(19) United States
(12) Patent Application Publication
(10) Pub. No.: US 2013/0003423 A1
(43) Pub. Date: Jan. 3, 2013

(54) MULTI-INPUT BIDIRECTIONAL DC-DC CONVERTER WITH HIGH VOLTAGE CONVERSION RATIO

(76) Inventors: Yujin Song, Daejeon-si (KR); Soo-Bin Han, Daejeon-si (KR); Sukin Park, Daejeon-si (KR); Hak-Geun Jeong, Daejeon-si (KR); Su-Yong Chae, Daejeon-si (KR); Gyu-Duk Kim, Daejeon-si (KR); Seung-Weon Yu, Daejeon-si (KR)

(21) Appl. No.: 13/282,064

(22) Filed: Oct. 26, 2011

(30) Foreign Application Priority Data
Jun. 29, 2011 (KR) 10-2011-0063734

(51) Int. Cl. H02M 3/335

(52) U.S. Cl. 363/21.02

(57) ABSTRACT

A multi-input bidirectional DC-DC converter with a high voltage conversion ratio is provided. The multi-input bidirectional DC-DC converter with a high voltage conversion ratio implements phase control loops independent from one another so as to realize independent control of charge and discharge in a plurality of energy storage modules, and thus a failure in one of energy storage modules does not affect the other energy storage modules. In addition, it is possible to easily add or remove a control loop that is controlled independently from other control loops.

### CROSS-REFERENCE TO RELATED APPLICATION(S)

This application claims the benefit under 35 U.S.C. §119(a) of Korean Patent Application No. 10-2011-0063734, in the Korean Intellectual Property Office, filed on Jun. 29, 2011, which is hereby incorporated by reference for all purposes as fully set forth herein.

### BACKGROUND

1. Field

The following description relates to a multi-input bidirectional DC-DC converter with a high voltage conversion ratio.

2. Description of Related Art

In recent years, active introduction of new renewable energy has increased in the developed countries as a solution for global warming and the depletion of fossil energy. However, new renewable energy, such as wind power or photovoltaic, greatly depends on climatic and geographical environments due to its intermittent output characteristics and accordingly has difficulties in predicting the generation amount of energy. Because of these characteristics, distributed generation system using renewable energy may cause instability of power grid and degradation of power quality.

Meanwhile, the output fluctuation of renewable energy can be reduced by a grid stabilization system with energy storage, such as battery, through parallel operation with a distributed generation system.

For parallel operation with a large-scale distributed generation system, a large-capacity energy storage system is required. Recently, lithium-ion batteries characterized in high energy density and a fast charge/discharge capability have increasingly gained attention. The large-capacity energy storage system using lithium ion battery comprises numerous cells connected in series and parallel connection.

In particular, in a battery module comprising cells with a low internal resistance, some cells connected in series connection may operate erroneously, thereby resulting in voltage drop, which leads to flow of a large amount of currents from other series cell modules. Accordingly, the battery lifespan can be shortened. Thus, there is a need for a large-capacity bidirectional DC-DC converter with a high voltage conversion ratio which can control charge or discharge of a low-voltage battery.

### SUMMARY

Exemplary embodiments of the present invention provide a multi-input bidirectional DC-DC converter with a high voltage conversion ratio allowing independent control of charge/discharge in multi-energy storage modules including battery cell modules or super capacitor modules, which are characterized in different impedances or different charging states.

Additional features of the invention will be set forth in the description which follows, and in part will be apparent from the description, or may be learned by practice of the invention.

Exemplary embodiments of the present invention provide a multi-input bidirectional DC-DC converter with a high voltage conversion ratio, including: a plurality of first input/output units configured to input a plurality of currents or output a plurality of voltages; a plurality of first half-bridges configured to control currents input from the respective first input/output unit or voltages output to the respective first input/output units, wherein the number of the first half-bridges is the same as the number of the first input/output units; a single second input/output unit configured to input a single current or output a single voltage; a plurality of second half-bridges configured to control a current input from the second input/output unit or a voltage output to the second input/output unit, wherein the number of the second half-bridges is the same as the number of the first half-bridges; and a plurality of transformers configured to transform currents from the first half-bridges to the second half-bridges or currents from the second half-bridges to the first half-bridges according to buck mode or boost mode, wherein the number of the transformers is the same as the number of the first half-bridges and the number of the second half-bridges.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a circuit diagram of a multi-input bidirectional DC-DC converter with a high voltage conversion ratio according to an exemplary embodiment of the present invention.

FIG. 2 is a circuit diagram illustrating an example of a three-phase multi-input bidirectional DC-DC converter with a high voltage conversion ratio according to an exemplary embodiment of the present invention.

FIG. 3 is a diagram illustrating waveforms showing the theoretical operations of the three-phase multi-input bidirectional DC-DC converter illustrated in FIG. 2.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

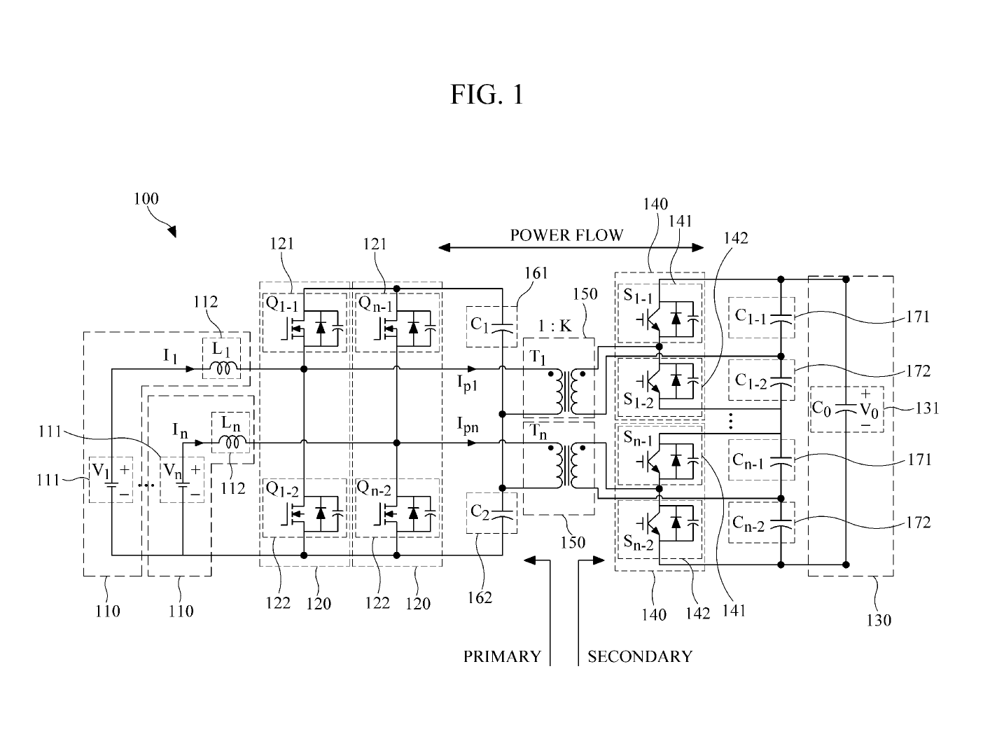

FIG. 1 is a circuit diagram of a multi-input bidirectional DC-DC converter with a high voltage conversion ratio according to an exemplary embodiment of the present invention. As shown in FIG. 1, multi-input bidirectional DC-DC converter 100 with a high voltage conversion ratio includes a plurality of first input/output units 110, a plurality of first half-bridges 120, a single input/output unit 130, a plurality of second half-bridges 140, and a plurality of transformers 150, wherein the number of the first half-bridges 120, the number of the second half-bridges 140 and the number of the transformers 150 are the same as the number of the first input/output units 110.

A plurality of the first input/output units 110 input a plurality of currents or output a plurality of voltages.

Since the bidirectional DC-DC converter is characterized in that both input and output ends perform current input or voltage output according to buck mode or boost mode, each of the first input/output unit 110 receives a current in buck mode, and outputs a voltage in boost mode.

In this case, the first input/output units 110 may include a plurality of chargeable or dischargeable energy storage components V₁, . . . , and Vₙ 111 and a plurality of inductors L1, . . . , Ln 112 which are connected in series to the respective energy storage components V₁, . . . , and Vₙ to store a current generated by the respective energy storage components 111.

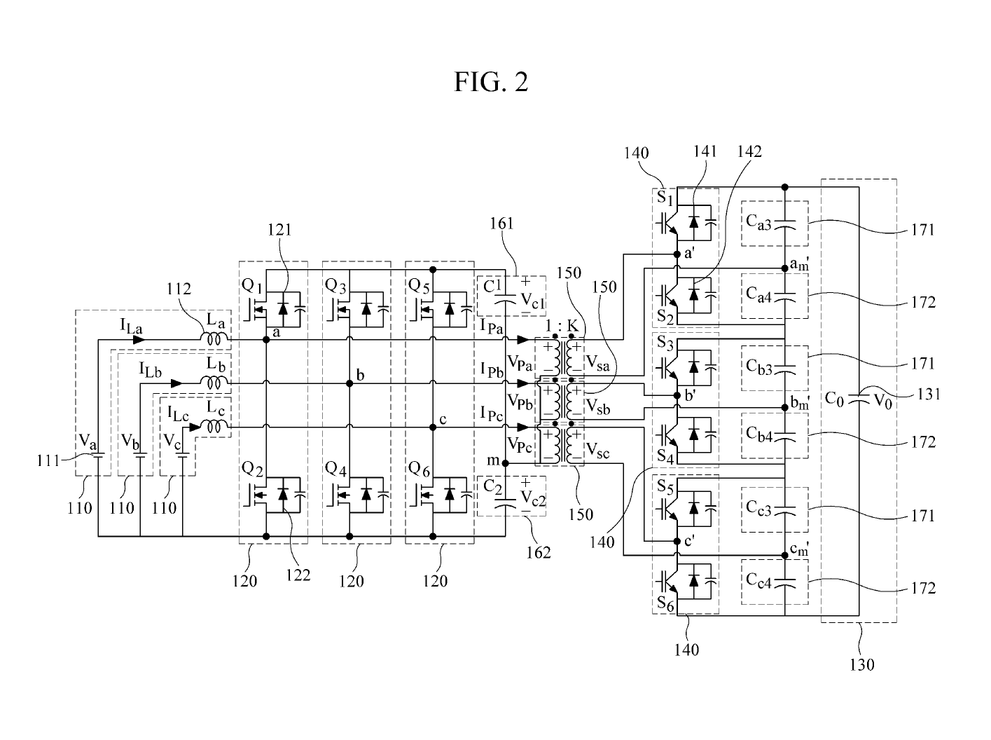

For example, in a case of 3-phase bidirectional DC-DC converter with a high voltage conversion ratio as shown in FIG. 2, each of the first input/output units 110 connected using Y-connection may include an energy storage module at each connection. Accordingly, the 3-phase bidirectional DC-DC converter with a high voltage conversion ratio includes three different is energy storage modules as the first input/output units 110.

If a first energy storage module Vₐ, a second energy storage module V_{b}, and a third energy storage module V_{c} are connected in parallel to one another, a failure of the second energy storage module Vₐ leads to a voltage difference between the first energy storage module Vₐ and the third energy storage module V_{c}. In this case, currents flow into the defective second energy storage module V_{b} from the first energy storage module Vₐ and the second energy storage module V_{c}, and thus the lifetime of the second energy storage module V_{b} can be shortened.

Therefore, according to the exemplary embodiments of the present invention, the multi-input bidirectional DC-DC converter 100 is implemented to include: a plurality of first input/output units 110 having two or more different energy storage components 111 under the control of different control loops; and inductors 112 connected in series to the respective energy storage components 111 so as to store a current produced by each of the energy storage modules.

In boost mode, each of inductors 112 stores a current output from each of the energy storage components 111, and discharges the stored current independently from one another. As a result, independent control of the energy storage modules can be achieved, and a failure in one of the energy storage modules does not affect the other energy storage modules connected to different loops, and thus the lifetime of the energy storage modules can be increased.

The number of the first half-bridges 120 is the same as the number of the first input/output units 110, and each of the first half-bridges 120 controls a current input from each of the first input/output units 110 and a voltage output to each of the first input/output unit 110. The first half-bridges are connected between the first input/output units 110 and the transformers 150, which will be described later, to allow zero voltage switching.

In this case, the first half-bridges 120 may include a plurality of switches 121 and 122. The switches 121 and 122 rectify high-frequency current pulses transformed by the transformers 150 to output a DC current to the first input/output unit 110 in buck mode, and modulate a DC current output from the first input/output unit 110 into a high-frequency current pulse and outputs the resultant high-frequency current pulses to the transformers 150 in boost mode.

Each of the first half-bridges 120 may be arranged in a primary side of the transformers 150. The switches 121 and 122 may be implemented as insulated gate bipolar transistors (IGBTs) or MOS field-effect transistors (MOSFETs).

In the multi-input bidirectional DC-DC converter 100, the primary side of the transformers 150 has a lower voltage than the secondary side. When the multi-input bidirectional DC-DC converter 100 is in buck mode, energy is transmitted from the secondary side having a higher voltage to the primary side having a lower voltage. When the multi-input bidirectional DC-DC converter 100 is in boost mode, energy is transmitted from the primary side having a lower voltage to the secondary side.

In the multi-input bidirectional DC-DC converter 100 according to the current embodiment, independent loop control for the first half-bridges 120 connected to the respective first input/output units 110 is possible. In a case where one first input/output unit 110 under the independent control of a loop is added to the multi-input bidirectional DC-DC converter 100, one first half-bridge 120 including a plurality of switches 121 and 122 are also added.

The single second input/output unit 130 may input a single current or output a single voltage. The second input/output unit 130 may include an energy storage capacitor Co 131 to store energy input from outside.

The multi-input bidirectional DC-DC converter 100 according to the current embodiment include a single second input/output unit 130 regardless of the number of the first input/output is units 110. In boost mode, an output from the multi-input bidirectional DC-DC converter 100 is a voltage cross the second input/output unit 130. For example, the second input/output unit 130 may be connected to a DC input terminal of a grid-connected inverter, to a DC output terminal of a distributed generation converter or to a DC input terminal of a load converter.

When the multi-input bidirectional DC-DC converter 100 is in boost mode, energy flows from the first input/output units 110 to the second input/output unit 130. The energy is stored in the energy storage capacitor C0 131 of the second input/output unit 130, and is supplied to an external power system (not illustrated) via a DC input terminal.

When the multi-input bidirectional DC-DC converter 100 is in buck mode, energy flows from the second input/output unit 130 to the first input/output units 110. The energy storage capacitor C0 131 of the second input/output unit 130 stores energy transferred from an external power system (not illustrated), and transfers the energy to the second input/output unit 130 via the second half-bridges 140 and the transformers 150.

The number of the second half-bridges 140 is the same as the number of the first half-bridges 120. The second half-bridges 140 control a current input by the second input/output unit 130 or a voltage output to the second input/output unit 130. The second half-bridges 140 are connected between the second input/output unit 130 and the transformers 150.

In buck mode, each of the second half-bridges 140 includes a plurality of switches 141 and 142 to convert a DC current input from the second input/output unit 130 into high-frequency current pulses and output the resultant pulses to the transformers 150 in buck mode, and to rectify high-frequency current pulses transformed by the transformers 150 and output a DC current to the second input/output unit 130 in boost mode.

The second half-bridges 140 are arranged in a secondary side of the transformers 150. A is plurality of the switches 141 and 142 may be implemented as IGBTs or MOSFETs.

In the multi-input bidirectional DC-DC converter 100 according to the current embodiment, the primary side of the transformers 150 has a lower voltage than the secondary side. When the multi-input bidirectional DC-DC converter 100 is in buck mode, energy flows from the secondary side having a higher voltage to the primary side having a lower voltage, and when the multi-input bidirectional DC-DC converter 100 is in boost mode, energy flows from the primary side to the secondary side.

In the multi-input bidirectional DC-DC converter 100 according to the current embodiment, independent loop control for the first half-bridges 120 connected to the respective first input/output units 110 is possible, and independent loop control for the second half-bridges 140 corresponding to the first half-bridges 120 is also possible.

In a case where one first input/output unit 110 under the independent control of a loop is added to the multi-input bidirectional DC-DC converter 100, one first half-bridge 120 including a plurality of switches 121 and 122 are also added, and concurrently one second half-bridge 140 including a plurality of switches 141 and 142 is added.

The number of the transformers 150 is the same as the number of the first half-bridges 120 and the number of the second half-bridges 140. The transformers 150 transform currents from the first half-bridges 120 and currents from the second half-bridges 140 according to buck mode or boost mode.

The first half-bridges 120 are connected at the primary side of the transformers 150 and the second half-bridges 140 are connected at the secondary side of the transformers 150. In boost mode, the transformers 150 transform a voltage from the primary side and apply the transformed voltage to the secondary side. In buck mode, reversely, the transformers 150 is transform a voltage from the secondary side and apply the transformed voltage to the primary side. Also, the transformers 150 electrically insulate a power source and a load. The transformers 150 with a predetermined turn ratio of 1:K transform the voltages from the primary side and the secondary side.

Since the multi-input bidirectional DC-DC converter with a high voltage conversion ratio according to the current embodiment configures control loops independent from one another with respect to the energy storage modules, a first half-bridge 120, a second half-bridge 140, and a transformer connected between the first half-bridge 120 and the second half-bridge 140 are added one by one each time adding one energy storage module to the multi-input bidirectional DC-DC converter.

According to another aspect of the present invention, the multi-input bidirectional DC-DC converter 100 may further include a plurality of lossless capacitors 161 and 162. The lossless capacitors 161 and 162 are connected in common to a plurality of the first half-bridges 120, and are, respectively, connected to the switches 121 and 122 in each first half-bridge 120. The lossless capacitors 161 and 162 are used for soft switching implementation.

According to another aspect of the present invention, the multi-input bidirectional DC-DC converter 100 may further include a plurality of lossless capacitors 171 and 172. The lossless capacitors 171 and 172, provided for each of the second half-bridges 140, are, respectively, connected to the switches 141 and 142 in each second half-bridge 140. The lossless capacitors 171 and 172 are used for soft switching implementation.

A connection between each elements of the multi-input bidirectional DC-DC converter 100 with a high voltage conversion ratio according to an exemplary embodiment will be described in detail with reference to FIG. 1 again. In an N-phase multi-input bidirectional DC-DC converter with a high voltage conversion ratio, n independent energy storage components V₁, . . . , Vₙ 111 are arranged in parallel to one another, and inductors L₁, . . . , Lₙ 112 are connected in series to the respective energy storage components V₁, . . . , Vₙ 111, thereby forming a plurality of first input/output units 110.

The first input/output units 110 are connected to the respective first half-bridges 120. Each of the first half-bridges 120 includes a plurality of the switches 121 and 122 which are connected in parallel to both ends of each of the energy storage components 111 and both ends of each of the transformers 150. Also, the switches 121 and 122 of each of the first half-bridges 120 are, respectively, connected in parallel to a plurality of the lossless capacitors 161 and 162, which are shared with the first half-bridges 120.

Each time adding an independent first input/output unit 110 to the multi-input bidirectional DC-DC converter 100 according to the current embodiment, a first half-bridge 120 is added as well. In this case, only a plurality of switches 121 and 122 that constitute the first half-bridge may be added, and a plurality of the lossless capacitors 161 and 162 are shared with the existing first half-bridges and the added first half-bridge.

The number of the transformers T₁, . . . , Tₙ 150 is the same as the number of the independent first input/output units 110. The transformers T₁, . . . , Tₙ 150 are high-frequency transformers. The transformers 150 are connected to the respective first half-bridges 120 in the primary side and the respective second half-bridges 140 in the secondary side with Y-Y connection.

One end at the primary side of each of the transformers 150 is connected to a contact point between corresponding switches Q₁₋₁, Q₁₋₂, . . . , Qₙ₋₁, and Qₙ₋₂ 121 and 122 included in each of the first half-bridges 120, and the other end at the primary side of each of the transformers 150 is connected to a contact point between the lossless capacitors C₁ and C₂ 161 and 162 shared with the first half-bridges 120.

One end at the secondary side of each of the transformers 150 is connected to a contact point between the switches S₁₋₁, S₁₋₂, . . . , Sₙ₋₁ and Sₙ₋₂ 141 and 142, and the other end at the second side of each of the transformers 150 is connected in parallel to a contact point between the lossless capacitors C₁₋₁, C₁₋₂, . . . , Cₙ₋₁, and Cₙ₋₂ 171 and 172 which are respectively connected in parallel to the switches 141 and 142 of each of the second half-bridges 140.

Each time adding an independent first input/output unit 110 to the multi-input bidirectional DC-DC converter 100 according to the current embodiment, a second half-bridge 140 is added as well. In this case, a plurality of lossless capacitors 171 and 172 are added to be, respectively, connected in parallel to a plurality of switches 141 and 142 of the second half bridge 140. The second half-bridge 140 is connected to the energy storage capacitor C₀ 131 of the second input/output unit 130.

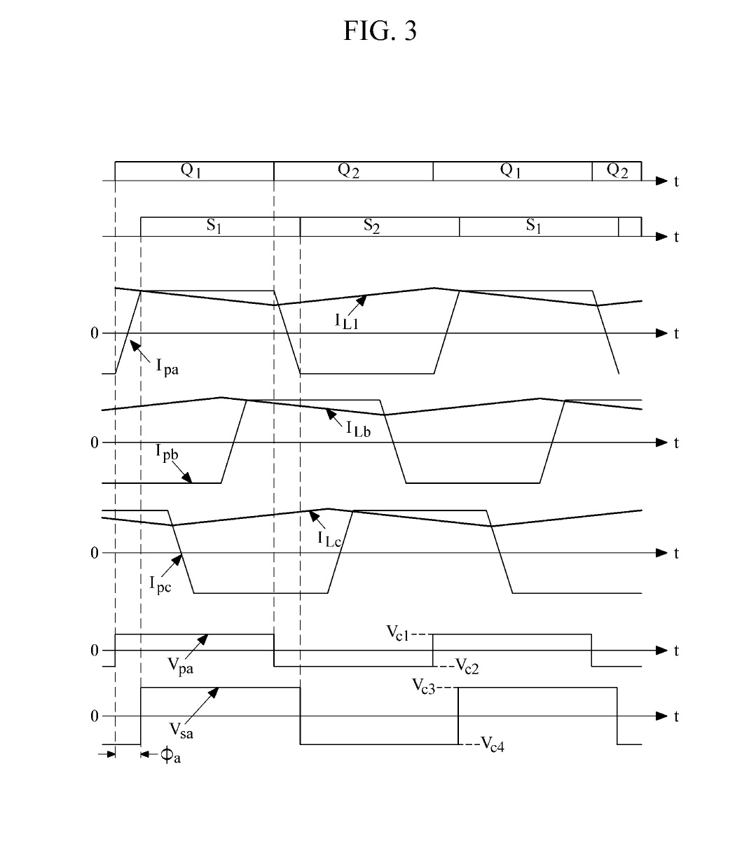

FIG. 2 is a circuit diagram illustrating an example of a three-phase multi-input bidirectional DC-DC converter with a high voltage conversion ratio according to an exemplary embodiment of the present invention. FIG. 3 is a diagram illustrating waveforms showing the theoretical operations of the three-phase multi-input bidirectional DC-DC converter illustrated in FIG. 2.

The three-phase multi-input bidirectional DC-DC converter with a high voltage conversion ratio includes three independent control loops. Also, the three-phase multi-input bidirectional DC-DC converter includes three-phase high frequency transformers 150 connected to both a primary side and a secondary side with Y-Y connection.

At the primary side of the three-phase high frequency transformer 150, three inductors Lₐ, L_{b}, and L_{C} 112 and three first half-bridges 120 are arranged. The first half-bridges 120 includes a plurality of switches Q₁ and Q₂, Q₃ and Q₄, and Q₅ and Q₆ 121 and 122, respectively, and share a plurality of lossless capacitors C₁ 161 and C₂ 162.

One ends at the primary side of the three-phase high frequency transformers 150 are, respectively, connected to contact points a, b, and c between the switches 121 and 122 of the respective first half-bridges 120. The other ends at the primary side of the transformers 150 are connected in common to a contact point m between the lossless capacitors 161 and 162.

In addition, at a secondary side of the three-phase high frequency transformers 150, three second half-bridges 140 and an energy storage capacitor C₀ 131 are arranged. The second half-bridges 140, respectively, include a plurality of switches S₁ and S₂, S₃ and S₄, S₅ and S₆ 141 and 142, and the switches S₁ and S₂, S₃ and S₄, S₅ and S₆ 141 and 142 of the respective second half-bridges 140 are connected to a plurality of lossless capacitors Cₐ₃ and Cₐ₄, C_{b3} and C_{b4}, and C_{c3} and C_{c4} 171 and 172, respectively.

One ends at the secondary side of the three-phase high frequency transformers 150 are, respectively, connected to contact points a′, b′, and c′ between the switches 141 and 142. In addition, the other ends at the secondary side of the three-phase high frequency transformers 150 are, respectively, connected to contact points aₘ′, bₘ′, and cₘ′ between the lossless capacitors 171 and 172 which are connected to the switches 141 and 142 of the respective second half-bridges 140.

Referring to FIG. 3, if a multi-input bidirectional DC-DC converter 100 with a high voltage conversion ratio includes an a-phase energy storage module Vₐ, there is a difference in a turn-on time between the switches 121 and 122 of each of the first half-bridges 120 and the switches 141 and 142 of the second half-bridge 140.

I_{La}, I_{Lb}, and I_{Lc} represent inductor input currents flowing, respectively, through a-, b-, and c-phase inductors Lₐ, L_{b}, and L_{c} 110. Iₚₐ, I_{pb}, and I_{pc} represent primary currents of the transformers 150. Vₚₐ represents an a-phase primary pulse voltage, and Vₛₐ represents an a-phase secondary pulse voltage. V_{c1} represents a voltage across the lossless capacitor C₁, and V_{c2} represents a voltage across the lossless capacitor C₂.

There is a phase shift φa between the a-phase primary square wave voltage and the a-phase secondary square wave voltage of the transformer 150. The phase shift determines the amount of power to be transmitted through the multi-input bidirectional DC-DC converter with a high voltage conversion ratio. Each-phase first half-bridge 120 and each-phase second half-bridge 140 operate at a duty ratio of 50%.

As illustrated in the above examples, a multi-input bidirectional DC-DC converter with a high voltage conversion ratio implements phase control loops independent from one another so as to realize independent control of charge and discharge in a plurality of energy storage modules, and thus a failure in one of energy storage modules does not affect the other energy storage modules. In addition, it is possible to easily add or remove a control loop that is controlled independently from other control loops.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A multi-input bidirectional DC-DC converter with a high voltage conversion ratio, comprising:
a plurality of first input/output units configured to input a plurality of currents or output a plurality of voltages;
a plurality of first half-bridges configured to control currents input from the respective first input/output unit or voltages output to the respective first input/output units, wherein the number of the first half-bridges is the same as the number of the first input/output units;
a single second input/output unit configured to input a single current or output a single voltage;
a plurality of second half-bridges configured to control a current input from the second input/output unit or a voltage output to the second input/output unit, wherein the number of the second half-bridges is the same as the number of the first half-bridges; and
a plurality of transformers configured to transform currents from the first half-bridges to the second half-bridges or currents from the second half-bridges to the first half-bridges according to buck mode or boost mode, wherein the number of the transformers is the same as the number of the first half-bridges and the number of the second half-bridges.

2. The multi-input bidirectional DC-DC converter with a high voltage conversion ratio of claim 1, wherein each of a plurality of the first half-bridges is further configured to comprise a plurality of switches configured to rectify high frequency current pulses transformed by the transformers and output a DC current to the first input/output unit in buck mode, and to modulate a DC current output from the first input/output unit into high frequency current pulses and output the resultant pulses to the transformers.

3. The multi-input bidirectional DC-DC converter with a high voltage conversion ratio of claim 1, wherein each of a plurality of the second half-bridges is further configured to comprise a plurality of switches configured to convert a DC current input from the second input/output unit into high frequency current pulses and output the resultant pulses to the transformers in buck mode and to rectify high frequency current pulses transformed by the transformers and output a DC current to the second input/output unit.

4. The multi-input bidirectional DC-DC converter with a high voltage conversion ratio of claim 2, further comprising:
a plurality of lossless capacitors configured to be shared by the first half-bridges and be connected, respectively, to the switches of the first half bridges for use in soft switching implementation.

5. The multi-input bidirectional DC-DC converter with a high voltage conversion ratio of claim 2, further comprising:
a plurality of lossless capacitors configured to be provided for the respective second half-bridges and be connected to the respective switches of each of a plurality of the second half-bridges for use in soft switching implementation.

6. The multi-input bidirectional DC-DC converter with a high voltage conversion ratio of claim 1, wherein each of a plurality of the first input/output units is further configured to comprise a chargeable/dischargeable energy storage component, and an inductor connected in series to the energy storage component to store a current produced by the energy storage component.

7. The multi-input bidirectional DC-DC converter with a high voltage conversion ratio of claim 1, wherein the second input/output unit is further configured to comprise an energy storage capacitor to store energy input from outside.
